(19) United States
(12) Patent Application Publication
(10) Pub. No.: US 2010/0211467 A1
(43) Pub. Date: Aug. 19, 2010

(54) COMPUTERIZED METHOD AND SYSTEM FOR EFFECTIVELY UTILIZING EMPTY-SPACES ON WEBSITES

(76) Inventor: Kumaresan Ramanathan, Nashua, NH (US)

Correspondence Address: Kumaresan Ramanathan, 76 Northeastern Blvd 31 A, Relona, Nashua, NH, 03062, US

(21) Appl. No.: 12/705,952

(22) Filed: Feb. 15, 2010

Related U.S. Application Data
(60) Provisional application No. 61/153,307, filed on Feb. 18, 2009.
(60) Provisional application No. 61/155,923, filed on Feb. 27, 2009.
(60) Provisional application No. 61/171,459, filed on Apr. 22, 2009.

(51) Int. Cl. G06F 17/00; G06Q 30/00

(52) U.S. Cl. 705/14.72; 705/14.73; 715/235

(57) ABSTRACT

A method and system are provided for effectively utilizing the empty-spaces that form on web-pages. The empty space on a web-page is measured and the space is filled with either new content or new advertisements. New content is either inserted or hidden content is made visible to reduce empty space. Empty space is also reduced by hiding items in columns other than where the empty space has formed. Reducing empty space by showing more advertisements helps web-portals and online publishers generate more revenue from their traffic. In addition, reducing empty space improves the aesthetic presentation of a web-page.

### CROSS REFERENCE TO RELATED APPLICATIONS

The present invention claims the benefit of co-pending U.S. Provisional Applications No. 61/153,307 filed on Feb. 18, 2009, Provisional application No. 61/155,923 filed on Feb. 27, 2009, and Provisional application No. 61/171,459 filed on Apr. 22, 2009.

### TECHNICAL FIELD

This invention relates to increasing effective usage of space on web-pages, and more particularly relates to reducing wastage of high-value space on web-pages by filling empty spaces in web-pages with content or advertisements.

### BACKGROUND INFORMATION

People browse the web to read information from portals. These portals are high traffic websites that often have thousands of pages of content available on them. The content available in these websites include news articles, how-to articles, blogs, user-generated content such as forum-discussions and comments, photos, videos, social connections, emails, search-results, and so on.

Though some websites generate revenue through subscription fees, the majority rely on advertising for their revenue. These websites enjoy a strong relationship with their audience. Readers visit these websites to learn about their favorite topics. Advertisers pay websites a fee for the privilege of presenting their message to the website's audience.

Advertisements are usually rectangular animations or graphic-images. Animations are usually in Adobe's flash format. Graphics are usually in GIF, JPEG, or PNG format. Advertisers pay based on the number of times an advertisement is shown or the number of clicks it receives. The number of clicks an advertisement receives depends on the number of times it is shown along with other factors.

A website earns more if it shows more advertisements. The total number of advertisement-views depend on the total number of page-views as well as the number of advertisement on each page. Showing more advertisements on each page can help a website earn more revenue from the same traffic.

The organization that operates a website is generally called a publisher. Publishers that manage large websites with thousands of articles usually use a content-management-system. A content management system (CMS) stores all the articles separately from the layout. The layout is specified by a layout-template. The publisher's website automatically combines the template with the content-article to create a fully laid out web-page.

The template specifies the widths of the columns of the page, the advertisements, the common graphics and so on. A template is designed for a content-article of average size. But few articles are of exactly average size. Articles are either longer or shorter than the average. This leads to empty space forming on websites. Consider a template that places the content-article in the left-column of a two-column layout. The right-column contains advertisements. When the article is very long, then the left-column will be longer than the right column. There will be empty space from the end of the right-column until the end of the page. Instead if the article is shorter than the average, then the left-column will be shorter than the right column. There will be empty space from the end of the left-column until the end of the page.

Currently there is a large amount of empty space on the web. Empty spaces occur on websites with high-traffic as well. Space on high-traffic websites is very valuable. If space on such pages is empty, then it represents a lost opportunity to earn revenue. Empty space is wasted space.

### SUMMARY

According to one aspect of the present invention addressing the needs discussed above, a computerized method is provided for displaying an advertisement within an area of empty space in a column of a web-page that is rendered on a user's web-browser. The method comprises the steps of measuring the empty space in the column, writing the opening tag of a new element, writing an advertisement using a script function call, writing the closing tag of the new element, and using CSS absolute positioning to place the new element within the area of empty space.

Since the location of the empty space might change over time, the location of the empty space is recomputed repeatedly and the advertisement moved if necessary so that it remains within the empty space.

According to another aspect of the present invention, a computerized method is provided for displaying an advertisement within an area of empty space in a column of a web-page that is rendered on a user's web-browser. The method comprises the steps of measuring the empty space in the column, writing the opening tag of a new element so that the tag contains CSS positioning which places the advertisement within the empty space, writing an advertisement using a script function call, and writing the closing tag of the new element.

According to another aspect of the present invention, a computerized method is provided for reducing an area of empty space in a column of a web-page that is rendered on a user's web-browser. The method comprises the steps of waiting until layout of the column of the web-page on the user's web-browser is complete, measuring the dimensions of the area of empty space that is formed on the user's web-browser within the column of the web-page, determining if addition of an item within the area of empty-space reduces the total quantity of empty space on the web-page, and adding the item within the area of empty-space if addition of the element reduces the total quantity of empty space on the web-page,

### BRIEF DESCRIPTION OF DRAWINGS

These and other features and advantages of the present invention will be better understood by reading the following detailed description, taken together with the drawings wherein:

FIG. 1 is an illustration of a web-page with empty space where the content in the left column is longer than the advertisements and content-widgets in the right column.

FIG. 2 is an illustration of a web-page with empty space where the content in the left column is shorter than the advertisements and content-widgets in the right column.

FIG. 3 is a modified version of the web-page illustrated in FIG. 1 where the empty space in the right column has been reduced by either adding new items to the right-column or making hidden items visible in the right-column.

FIG. 4 is a modified version of the web-page illustrated in FIG. 2 where the empty space in the left column has been reduced by either hiding items in the right column, or by deleting items from the right column.

FIG. 5 is an illustration of how a marker-DIV that indicates the end of a column can be used to measure the extent of the empty space.

FIG. 6 is an illustration of how an advertisement may be placed in the empty space at the end of a column using an absolutely positioned DIV.

FIG. 7 is a flowchart illustrating how new items may be added to a column to reduce empty space in that column.

FIG. 8 is a flowchart illustrating how hidden items may be made visible within a column to reduce empty space in that column.

FIG. 9 is a flowchart illustrating how empty space within a column may be reduced by hiding items in a different column.

FIG. 10 is a flowchart illustrating how empty space within a column may be reduced by removing (deleting) items in a different column.

FIG. 11 is a flowchart illustrating how an advertisement may be inserted within empty spaces by using an absolutely positioned DIV.

### BRIEF DESCRIPTION OF CODE LISTINGS

For a better understanding of the features and benefits of the present invention, working code has been provided in the code listings. Each submitted ASCII text file has names of the form listing1.txt, listing2.txt, and so on. The .txt file extensions should be renamed to .html before the files can be used. The file listing1.txt should be renamed to listing1.html, the file listing2.txt should be renamed to listing2.html and so on. The HTML code has been written for Mozilla Firefox 3.6 and Microsoft Internet Explorer version 8 on Windows 7. No browser settings should be changed from the defaults for those browsers on Windows 7. The files may be accessed from a web-server such as Apache. The files may also be opened directly from a directory on a Windows 7 computer, but in that case the browsers might request security permissions. All required permisions should be granted to the browsers.

listing1.html is a web-page with empty-space in the right column.

listing2.html is a web-page with javascript code that reduces empty space in the right-column by adding new items in the right-column.

listing3.html is a web-page with javascript code that reduces empty space in the right-column by making hidden items visible in the right column.

listing4.html is a web-page with empty space in the left-column.

listing5.html is a web-page with javascript code that reduces empty space in the left-column by hiding items in the right column.

listing6.html is a web-page with javascript code that reduces empty space in the left-column by removing (deleting) items in the right-column.

listing7.html is a web-page with an advertisement that is inserted in empty space using an absolutely positioned DIV.

listing8.html is a web-page with javascript that has substantially the same behavior as listing2.html, except that the javascript is run only after the page loads completely.

### DETAILED DESCRIPTION OF THE PREFERRED EMBODIMENTS

A number of subprocesses are described herein as being part of an overall layout optimization process. Each of these sub-processes or methods and the systems that implement these methods can also be used independently. The preferred embodiment enabled a web-page to optimize the layout of advertisements and content so that user-engagement of the page is increased.

Web-pages are designed using HTML elements such as P (paragraph), DIV, SPAN, TABLE, and so on. Some HTML elements are of fixed known size. This includes HTML elements that have had CSS styles with height and/or width specified. Even without CSS, some HTML elements such as tables can have their dimensions precisely specified. Other HTML elements are of unspecified dimensions, especially those that have not had any CSS styles for dimensions applied. For example, a paragraph (<P> tag) without CSS styles is of unspecified height. The actual height of a paragraph element depends on the browser, the browser-settings, the browser-version, the operating system and other such factors that are not entirely under the control of the designer of the web-page. If the width of the containing element of the paragraph has not been specified, then the height of the paragraph will also depend on the width of the browser window.

The dimensions of text elements are usually not precisely known until the element has been rendered in a particular user's browser. Word-breaks, hyphenation, line-spacing, letter-spacing, font-display and other attributes of the text may vary from one user's browser to another. Since these attributes determine the final dimensions of the text, the precise dimensions of text vary from one instance of a browser to another.

Since the dimensions of text elements in a HTML web-page are dependent on so many factors, a good way to determine the size of an element is to wait until the element has been rendered in the particular user's browser and then measure the dimensions of the element using javascript (or any other browser scripting language).

When elements of unspecified dimensions are combined with elements of fixed dimensions, then empty space can result on the page. For example, consider a layout with two columns of specified widths. Suppose the left column contains text and the right-column contains fixed size elements such as graphic images. The designer of this page intended the two columns to be of the same height and he/she ensured that the two are of equal height in the designer's browser. But the height of the left-column varies from browser to browser because it contains text of unspecified height. So it will be taller in some browsers and shorter in other browsers. If the left-column is taller than the right column, there will be empty-space at the end of the right column. If the left column is shorter, there will be empty space at the end of the left-column.

So far we have considered the formation of empty space in a web-page caused by the differences in the rendering behavior of different browsers. Another cause of empty space is content which is itself variable. For example, consider a web-page that contains user-generated text such as comments, forum postings, and so on. Since the content can be changed by users, the text itself can change each time the page is rendered in a browser. This can result in the formation of large areas of empty space on the page.

Another cause for empty space on web-pages is the use of templates to format articles from a content-management-system. The template is designed for an average length article, but the articles differ in length. So empty space is formed when the article is longer or shorter than the average.

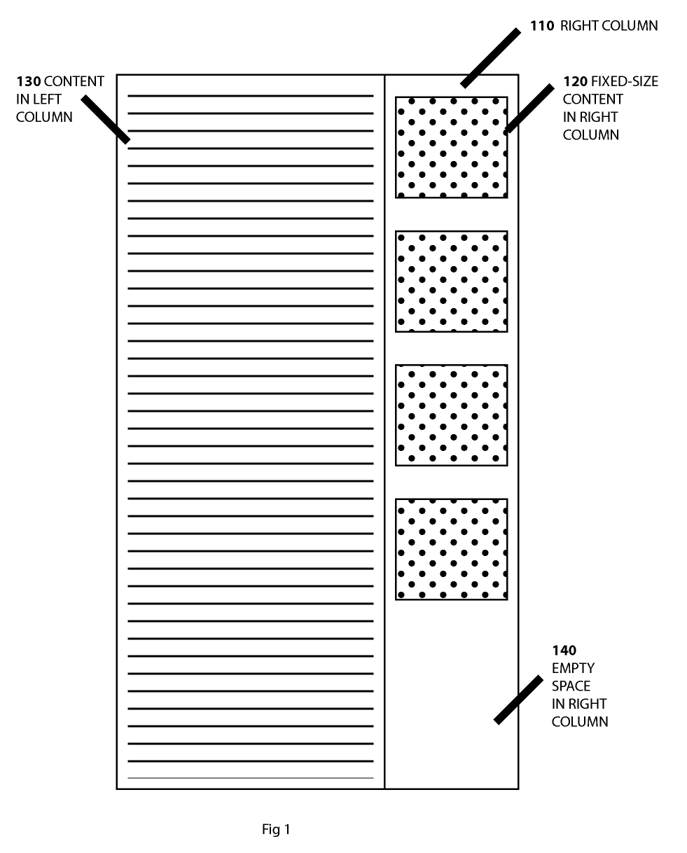

FIG. 1 shows a two-column layout. The right column 110 contains items 120 that are of a specified size. Since the sizes are specified, their dimensions are known precisely. On the other hand, the left-column contains text 130 of unspecified height. The width of the left-column is known, but the height can vary from browser to browser. In the drawing shown, the left-column 130 is longer than the right-column 110. This results in empty space 140 being formed at the end of the right-column.

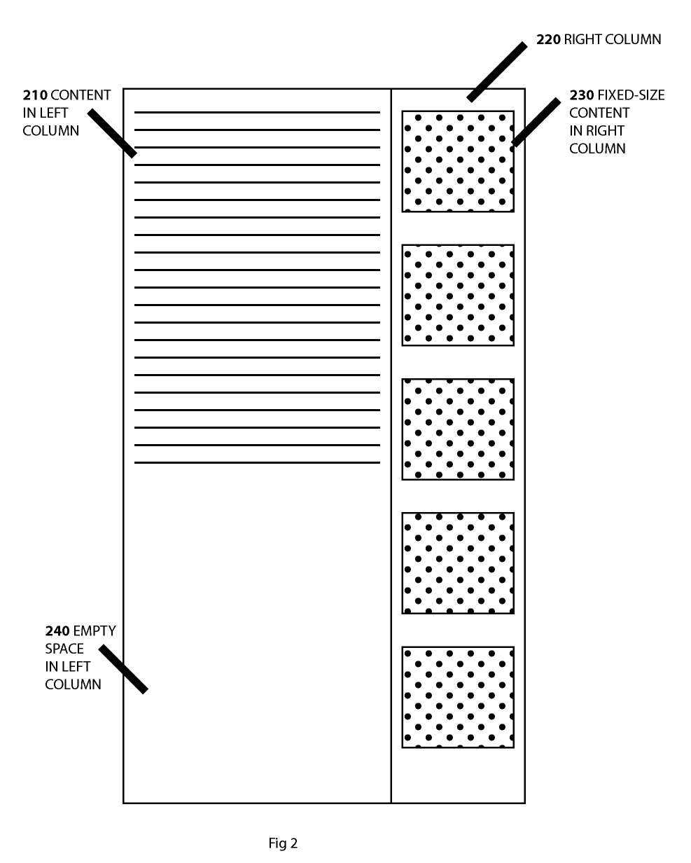

FIG. 2 shows a two-column layout. The left-column text 210 is shorter than the contents 230 of the right-column 220. This situation can arise when the article in the left-column is shorter than the average article that the template was designed for. Fixed-size content in the right-column 230 will have been inserted when the template is applied on the article. This results in empty space 240 forming at the end of the left-column.

Observe that the empty space forms because the two columns have a synchronized start point and end point. That is, both columns begin at the top of the page, and they continue to the end of the page. If the content in one column is longer than the content in the other, then the shorter column has empty space at its end.

In general, empty space forms when the dimensions of a column are larger than what is required by the content within it. In the two-column layout illustrated in FIG. 1, both the columns are synchronized and have the same height (approximately the height of the page). The height of the left column determines the page-height in this case. The right-column is forced to be the same height as the left-column though the content within the right-column doesn't need so much space. Therefore there is empty space in the right-column. The quantity of empty space can be known only at the time the page is rendered on the user's browser because the height of the left-column can depend on browser settings.

Consider listing1.html. The web-page in this file has content in the left-column that is longer than the content in the right-column. So there is empty space in the right-column. This web-page is similar to the drawing illustrated in FIG. 1.

Consider listing2.html. The web-page in this file has content in the left-column that is shorter than the content in the right-column. So there is empty space in the left column. This web-page is similar to the drawing illustrated in FIG. 2.

Empty space is wasted space. Since space on high-traffic websites is very valuable, we try to reduce empty space. Furthermore, it is clearly impractical to manually tweak each page for each browser just before it is rendered to reduce empty space. So we need a fully automated (computer executable) process for reducing empty space.

The present invention reduces empty space by (a) adding new items in the column with empty space (b) making previously hidden items visible in the columns with empty space (c) hiding items in other columns, and (d) deleting items from other columns. The changes in the web-page to reduce empty space are made either after the page has completely loaded, or while the page is still loading.

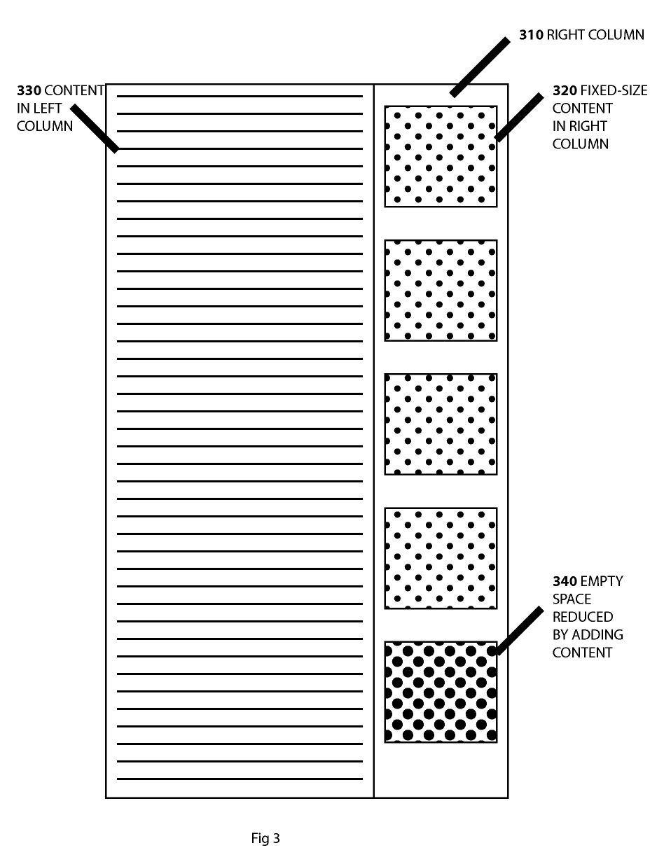

FIG. 3 shows how the web-page shown in FIG. 1 may be modified to reduce empty space. An item 340 of fixed size has been added to the right-column. Addition of this item 340 reduces the amount of empty space.

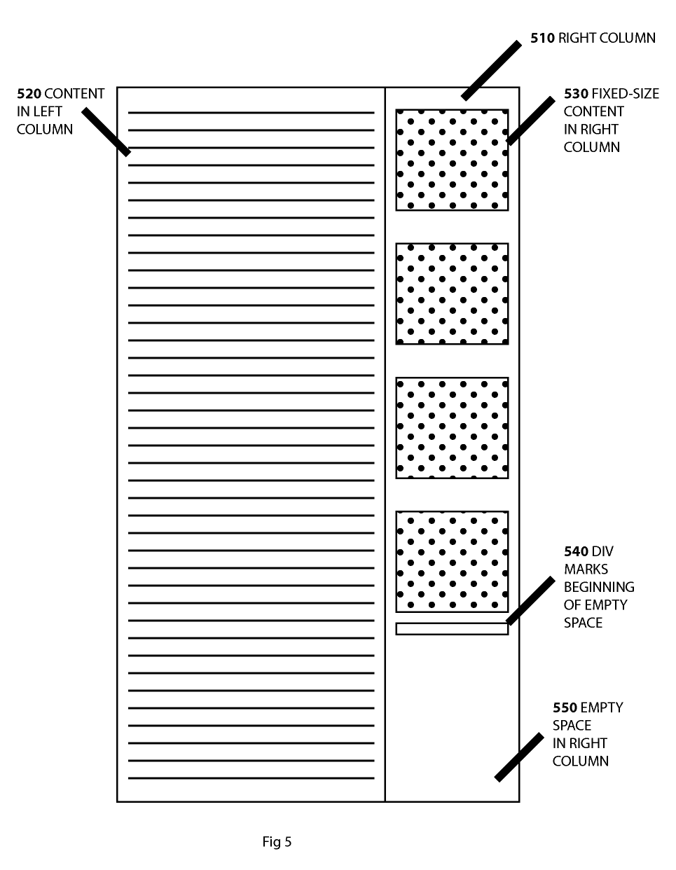

Before we modify the page, we first need to determine how much empty space is available. FIG. 5 illustrates how this is accomplished. The web-page contains left-column content 520 that is longer than the content 530 in the right-column 510. To determine the quantity of empty space, we have a marker DIV 540 which marks the end of the content in the right-column and the beginning of the empty space. We find the y-location of this DIV. We also find the total height of the page. The difference between the two is the amount of empty space.

Alternative means to find the quantity of empty space may be employed. The height of the content in the right column 530 may be computed. The height of the left-column content 520 may also be computed. The difference is the height of the empty area.

In FIG. 3, there are two ways to add item 340. We can either insert a new item or we can make a previously existing hidden item visible. [Note: The henceforth add/adding/addition of an item refers to the inclusion of an item either by insertion of a new item or by making a previously hidden item visible.]

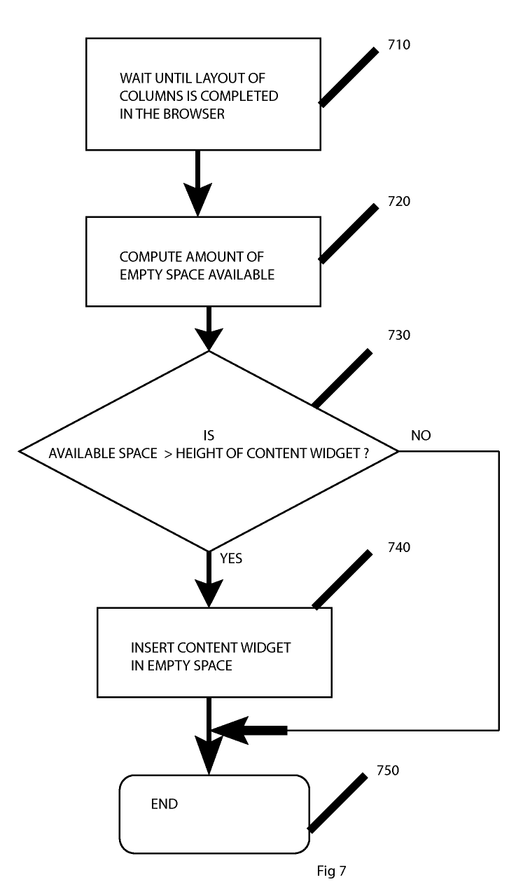

We will first discuss the steps to insert a new item. FIG. 7 is flowchart of the steps to insert a new item. We start with step 710 and wait until the layout of the columns is completed in the browser. Browsers usually render columns as soon as the code for the columns has been loaded. There is no need to wait until the entire page finishes loading.

The next step 720 is to compute the amount of empty space available. The mechanism illustrated in FIG. 5 may be used to compute available space.

Step 730 compares the height of the widget that is being considered for insertion with the height of the empty space. If there is sufficient space available, then the widget is inserted in step 740. Otherwise we skip directly to the end (step 750).

Our aim is to reduce the total quantity of space on the web-page that is empty. So an alternative to comparing the height of the item with the empty space is to check if addition of the item will reduce the total amount of empty space on the page. If so, we can go ahead and add the item.

The file listing2.html contains an implementation of the steps discussed in FIG. 7.

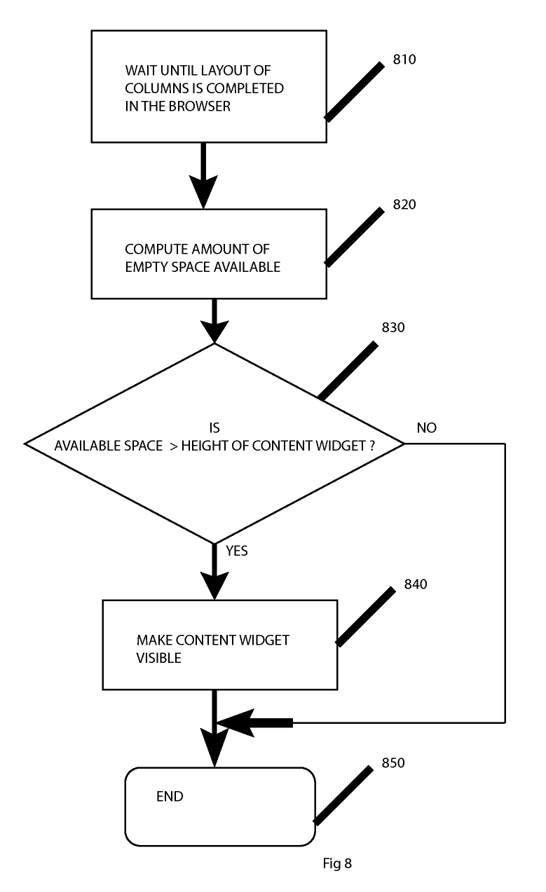

The other way to add item 340 is to make a previously existing hidden item visible. FIG. 8 is a flowchart of the steps to reduce empty space by making an item visible. We start with step 810 and wait until the layout of the columns is completed. In step 820, we compute the amount of empty space available. In step 830 we compare the height of the hidden item and the available space. Note that a hidden item doesn't occupy space in the layout. The term “hidden” here corresponds to a CSS style of display=‘none’. It doesn't correspond to the CSS style of visibility=‘hidden’ since an item with hidden visibility in CSS occupies space in the layout. If there is sufficient empty space, in step 840 the hidden item is made visible. Otherwise, we skip directly to the end 850.

As mentioned earlier, an alternative to comparing the height of the item with the empty space is to check if addition of the item will reduce the total area (that is, quantity) of empty space on the page. If it will then we go ahead and make the hidden item visible.

The file listing3.html contains an implementation of the steps discussed in FIG. 8. In listing3.html, the DIV of ID widget 2 is the previously existing item which is made visible to reduce empty space.

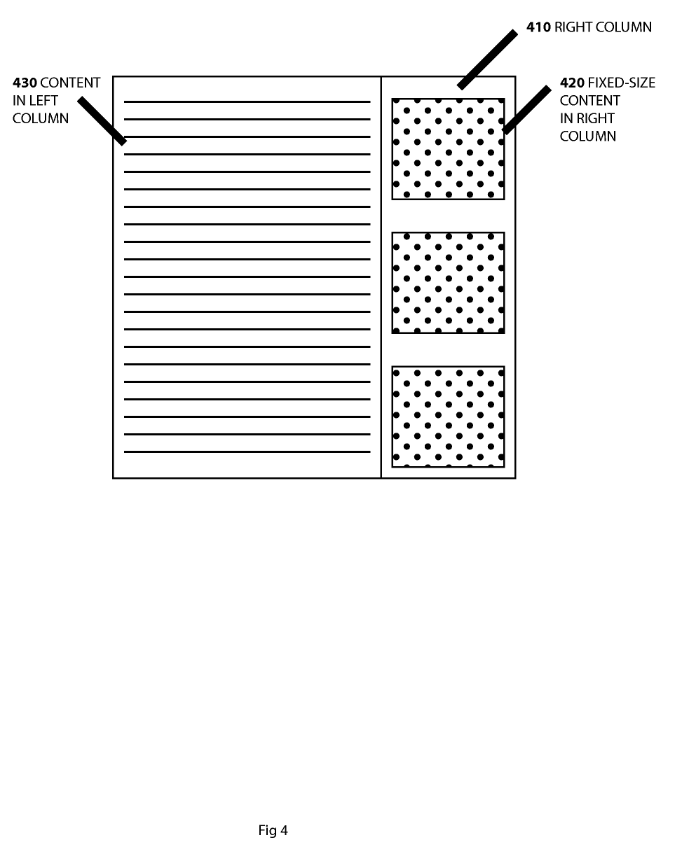

FIG. 4 is a modified version of the web-page in FIG. 2. The content in the left column 430 is approximately equal in height to the content 420 in the right-column 410. This has been accomplished by suppressing items in the right column. Items may be suppressed by either deleting them from the page entirely, or by hiding them with a CSS style of DISPLAY being set to ‘none’.

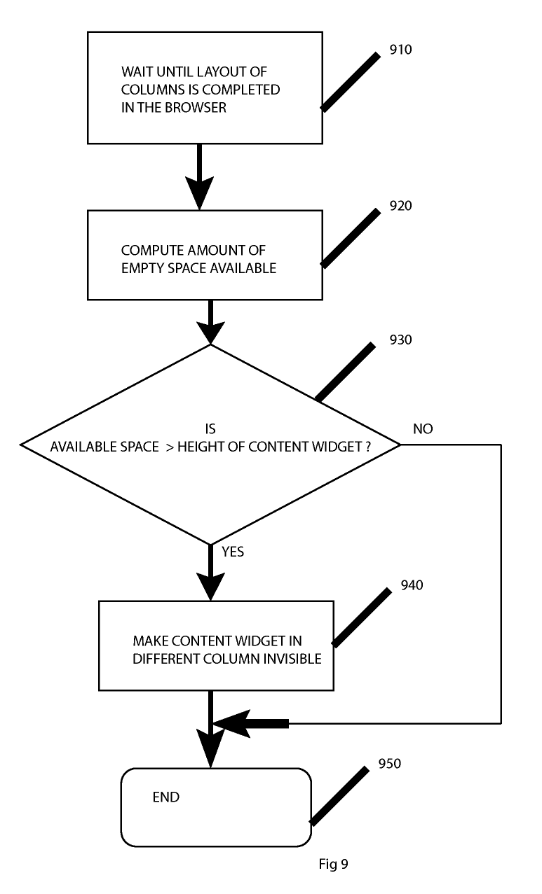

We will first consider the steps for suppressing items by hiding them. FIG. 9 is the flowchart for how the web-page shown in FIG. 2 can be converted to the web-page shown in FIG. 4 through computerized means. The first step 910 is to wait until the layout of the columns is completed in the browser. Next step 920 computes the quantity of empty space available in the left column 240 of the page in FIG. 2. In step 930 we compare the height of the empty space with the height of the content-widget. Note that the empty space is in the left column while the widget is in the right column. If there is sufficient empty space in the left column, we hide the widget in the (other) right-column in step 940. Otherwise, we skip to the end 950.

Repeating these steps of FIG. 9 on the web-page in FIG. 2 until no more items can be hidden results in the web-page of FIG. 4. Column 410 has two fewer items visible than column 220.

The file listing5.html is an implementation of a process that is equivalent to the one illustrated in FIG. 9. The difference is that instead of repeating all the steps of FIG. 9 twice and hiding items one by one, if there is sufficient space to hide two items in the right-column, it hides them together.

Instead of hiding items in the right-column to reduce the empty space in the left-column, we can choose to delete the items entirely. The HTML DOM allows us to delete items in a variety of ways. In the present embodiment, we delete an item by setting innerHTML of the item's parent element to be empty.

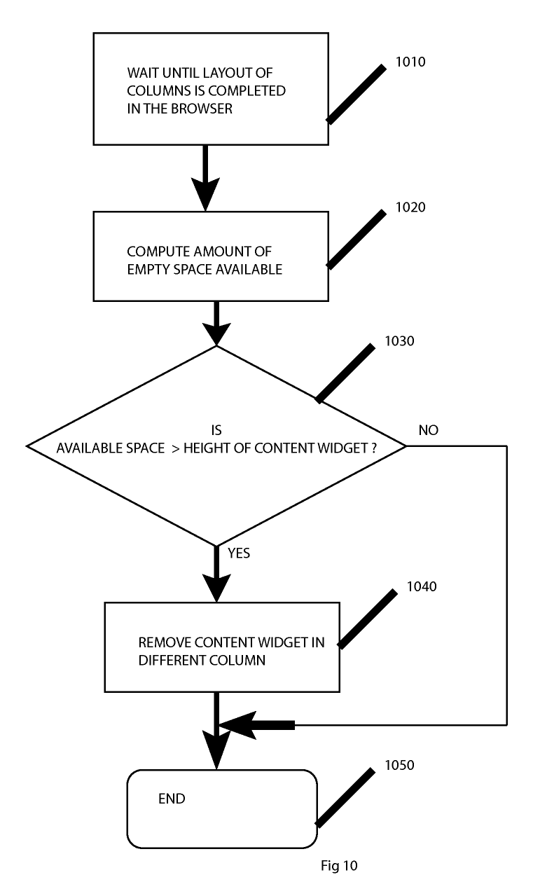

The flowchart in FIG. 10 illustrates the steps to reduce empty space by deleting items. In step 1010 we wait until the layout of the columns in the browser is complete. In step 1020 we compute the empty space in the left-column and compare it to the height of the item in the right-column in step 1030. If the empty space is taller than the widget, we delete the widget in step 1040. Otherwise we skip to the end 1050.

The file listing6.html implements a process that is similar to the steps in FIG. 10.

So far the source code we have discussed has computed the available empty space immediately after the columns are loaded into the browser. Alternatively we can wait until the entire page is completely loaded. The file listing8.html is a variation of listing2.html. The difference is that in listing8.html the onload event is used to trigger the process for reducing empty space.

So far we have inserted, deleted, and changed the visibility of content-widgets. A content-widget can be anything that fits in a web-page. As explained earlier advertisements are probably the most valuable widgets to insert or make-visible.

Unfortunately advertisements bring some complications. Advertisements that are placed on a web-page are the subject of some kind of fee-for-service contract between the publisher and the advertiser. The contract will specify exactly how many advertisements are to be shown, and in which positions. The count of the number of impressions of any advertisement is the subject matter of audits. So advertisements cannot be removed or inserted after a page has loaded because it will cause the count of impressions at the advertisement-server to go wrong. Similarly advertisements cannot be hidden or made-visible by scripts on the browser-client because of contractual obligations. Many advertisements cannot be manipulated through DOM functions that insert, delete or move nodes. Contracts often specify the javascript code that may be used to insert an advertisement into a web-page.

However most contracts permit publishers to use CSS positioning to set the page-coordinates of elements that contain advertisements.

Advertisements are usually to be placed on web-pages using a call to a javascript function. For example: <script type=“text/javascript”>insert_advertisement( );</script>

The call to the function insert_advertisement( ) will use document.write( ) to insert new code at that location for displaying the advertisement. The new code might include iframe tags, embed tags, script tags or any other HTML element. Each advertisement-server or advertisement network will have a different javascript function to call. For example OAS_AD( ) is a frequently used function that invokes a popular advertisement server. But many of these functions for inserting advertisements behave in a manner similar to the insert_advertisement( ) function discussed here.

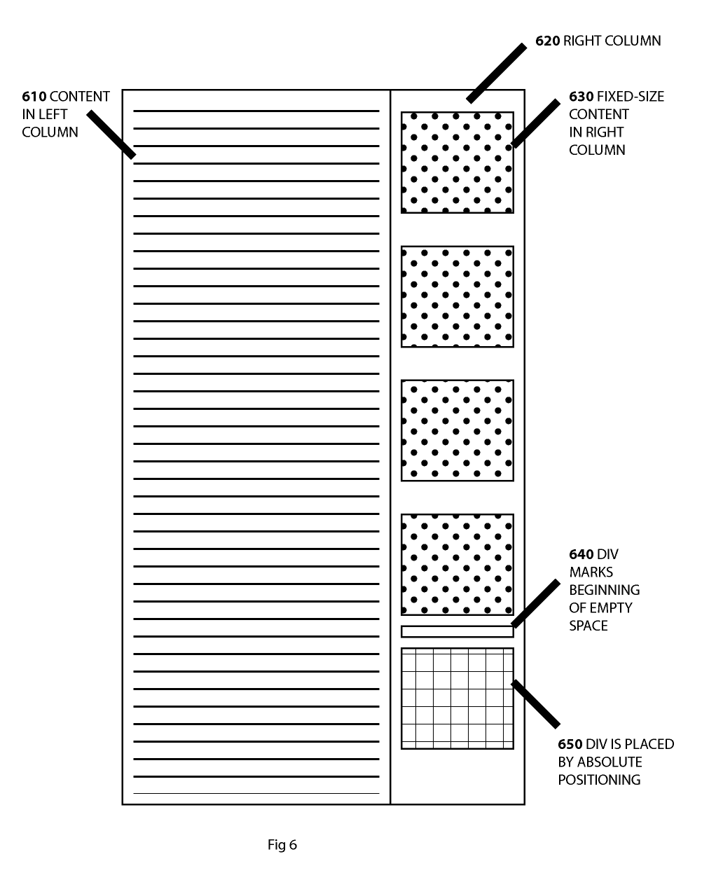

FIG. 6 is an illustration of a web-page where the content in the left-column 610 is longer than the content 630 in the right column 620. Using the marker DIV method illustrated in FIG. 5, the amount of empty space has been measured using the marker 640 and a new DIV 650 has been placed in the empty space.

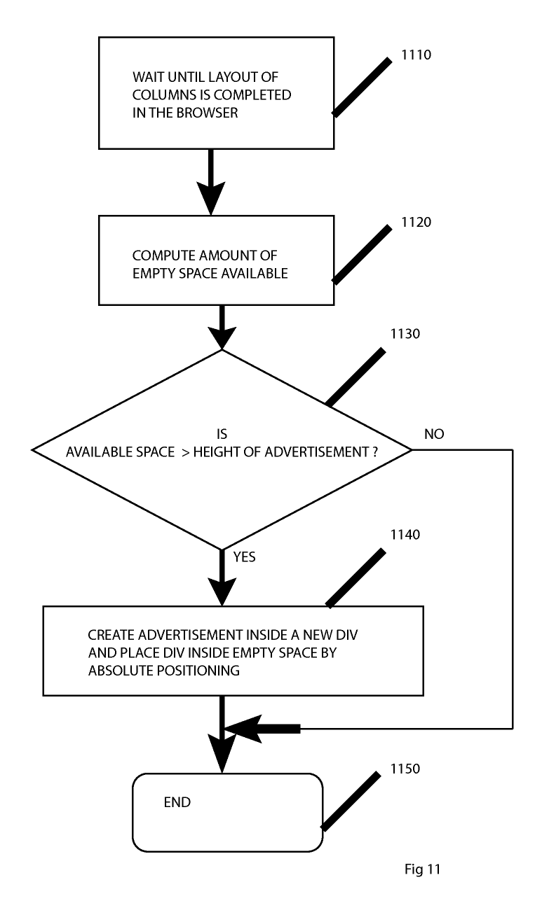

FIG. 11 is a flowchart of the steps in this process. We begin by waiting until the layout of the columns has been completed in the browser, step 1110. Next we measure the amount of empty space available, step 1120. We compare the available space with the height of the advertisement in step 1130. If there is sufficient space, we create a new <DIV> tag using document.write( ) insert the advertisement by calling the appropriate function such as insert_advertisement( ) and then we write out the closing </DIV> tag using document.write( ). The coordinates of this newly created DIV (which contains the advertisement we are inserting) is set to be the empty space. If there is not enough empty space, we skip to the end 1150.

A better understanding of this process may be attained by studying listing7.html.

The javascript code within the head-tag defines a function insert_advertisement ( ) as follows:

function insert_advertisement( )
{
document.writeln(‘<div style=“width:300px; height:250px;
background-color:#F00;”>This rectangle represents an
advertisement or other content created dynamically</div>’);
}

This function uses document.writeln( ) to create a DIV. The operation of this function is similar to the way other advertisement scripts operate. So for the purposes of this discussion, this function can be used as a representative script for inserting advertisements.

The process of reducing empty space is implemented by the code at end of the file, just before the end of the body-tag. The code is below:

10: <script type=“text/javascript”>
20: var available_space =
relona_posy(document.getElementById(“footer”))−
relona_posy(document.getElementById(“end_of_right_column”));
30: if(available_space > 250)
40: {
50: document.getElementById(“insertion_point”).innerHTML = ‘<div
id=“placeholder” style=“width:300px; height:250px;”></div>’;
60: document.writeln(‘<div id=“inserted_advertisement”
style=“position:absolute;”>’);
70: }
80: </script>
90: <script type=“text/javascript”>if(available_space >
250)insert_advertisement( );</script>
100: <script type=“text/javascript”>
110: if(available_space > 250)
120: {
130: document.writeln(‘</div>’);
140: }
150:
160: </script>
170: <script
type=“text/javascript”>relona_follow_position(“placeholder”,
“inserted_advertisement”);</script>

The lines in the code have been numbered for the purpose of this discussion. The line-numbers are of the form “10:”,“20:”, and so on.

We will now discuss this code line-by-line. Line 20 computes the amount of empty space available by using the function relona_posy( ) that computes the y-coordinate of any HTML DOM element. If there is enough empty space (more than 250 pixels) then line 50 inserts a placeholder into the right-column. This placeholder is a DIV tag, so it is acceptable to use innerHTML to insert this into the DOM.

Line 60 uses document.writeln to insert the opening tag of a DIV with absolute positioning.

Instead of CSS-style of position:absolute, we can also use CSS-style of position:relative, or any other style that allows coordinates of the DIV to be set. For position:relative relative coordinates will need to be used.

Currently, this source code is implemented so that the absolute position is set later by accessing the new DIV through the DOM. Instead we can also choose to write the position coordinates in a CSS-style within the tag itself.

Instead of using a DIV, we could have used any element whose coordinates can be specified.

Line 90 first checks the availability of empty space and then calls the insert_advertisement( ) function. This writes out the code for an “Advertisement”. Observe that this happens after the opening DIV tag has been written in line 60.

Line 110 checks availability of empty space and line 130 writes out the closing DIV tag.

Observe that lines 60, 90 and 130 have used document.writeln( ) calls to wrap the advertisement within an absolutely positioned DIV tag. The code generated by these document.writeln( ) calls is appended to the page at the very end after the layout of the columns is complete. However since the newly created DIV is absolutely positioned, we can place it wherever we wish on the page.

Finally line 170 calls the function relona_follow_position( ). This function places the DIV with ID “inserted_advertisement” exactly above the DIV of ID “placeholder”. Since the DIV of ID “placeholder” is in the empty space, this call places the newly created DIV containing the advertisement exactly in the empty space. The function repeatedly checks the location of the placeholder and adjusts the position of the advertisement to be always above the placeholder element. So the advertisement will always be over the placeholder even if the layout were to change or shift at some later point in time. Observe that we are using the placeholder to indicate the location of the empty space. That is, computing the location of the placeholder is equivalent to computing the location of the empty space.

The creation of the opening DIV tag, the advertisement, and the closing DIV tag are in different <script> sections to avoid browser-dependent behavior.

Observe that the new items can be inserted anywhere in a column, and not necessarily at the end of the column. Similarly when we delete or hide items, we can hide/delete items that are anywhere within a column, and not necessarily at the end of the column.

Empty space can also be reduced by moving items from one column to another. But this behavior is for practical purposes merely the combination of removing an item from one column and inserting an item in another column. Since the fundamental actions (inserting, hiding, deleting, . . . ) have been covered in this discussion, the material presented here should be understood to also include combinations of these actions.

The invention claimed is:

1. A computerized method for displaying an advertisement within an area of empty space in a column of a web-page that is rendered on a user's web-browser, said method comprising
measuring the location and dimensions of said area of empty space that is formed on said user's web-browser within said column of said web-page,
writing the opening tag of a new element with CSS-styles specifying coordinates of a point within said area of empty space,
calling a script function to write said advertisement,
writing the closing tag of said new element,
whereby said web-page is able to increase advertisement earnings.

2. A computerized method for displaying an advertisement within an area of empty space in a column of a web-page that is rendered on a user's web-browser, said method comprising
measuring the location and dimensions of said area of empty space that is formed on said user's web-browser within said column of said web-page,
writing the opening tag of a new element,
calling a script function to write said advertisement,
writing the closing tag of said new element,
obtaining the DOM handle of said new element and using said DOM handle to set coordinates of said new element to be within said area of empty space,
whereby said web-page is able to increase advertisement earnings.

3. The computerized method of claim 1 further comprising the step of repeatedly determining location of said area of empty space and updating coordinates of said advertisement to be within said area of empty space.

4. The computerized method of claim 2 further comprising the step of repeatedly determining location of said area of empty space and updating coordinates of said advertisement to be within said area of empty space.

5. A computerized method for reducing an area of empty space in a column of a web-page that is rendered on a user's web-browser, said method comprising:
waiting until layout of said column of said web-page on said user's web-browser is complete,
measuring the dimensions of said area of empty space that is formed on said user's web-browser within said column of said web-page,
determining if addition of an item within said area of empty-space reduces the total quantity of empty space on said web-page,
adding said item within said area of empty-space if addition of said element reduces the total quantity of empty space on said web-page,
whereby the total quantity of empty space on said web-page is reduced.
